(19) United States
(12) Patent Application Publication
(10) Pub. No.: US 2004/0038184 A1
(43) Pub. Date: Feb. 26, 2004

(54) Auxiliary method for judging oral cavity conditions, auxiliary device for judging oral cavity conditions, and auxiliary program for judging oral cavity conditions

(76) Inventors: Masaru Adachi, Hyogo (JP); Hiromoto Namikawa, Hyogo (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/240,517

(22) PCT Filed: Jan. 29, 2002
(86) PCT No.: PCT/JP02/00641

(30) Foreign Application Priority Data
Jan. 30, 2001 (JP) 2001-021039

(51) Int. Cl. A61C 5/00

(52) U.S. Cl. 433/215

(57) ABSTRACT

When an input screen for inputting points regarding each of the 28 teeth in total is displayed on the display unit (40), the operator inputs points for each tooth upon referring to the assessment criterion which associates the condition of the dental framework and periodontal framework with the points corresponding to the respective frameworks. Points regarding each input tooth are stored in the main memory (20). When the input of points for all teeth is completed, the CPU (10) reads the points regarding each tooth from the main memory (20) and calculates the total number of points from the points of each tooth, and further calculates the tooth age by diving such total number of points by three. The calculated tooth age is displayed on the display unit (40). Accordingly, the tooth age is provided to the operator as effective auxiliary information upon such operator judging the intraoral condition.

### BACKGROUND OF THE INVENTION

1. Field of the Invention

The present invention pertains to a method of providing auxiliary data to become an index upon objectively judging the intraoral condition, and further to a device realizing such method and to a program for making a processor execute such method on a computer system.

2. Description of the Related Art

Japanese Patent No. 3040980 (hereinafter referred to as the “conventional art”) proposes an index referred to as an oral cavity age as the objective index for judging the oral intracavitary condition and, in relation thereto, discloses a judging device of oral intracavitary conditions.

In summary, the conventional art calculates the oral cavity age of the person to be evaluated (consultee) with the first to third regression formulae obtained by performing approximate processing to existing statistical data. In detail, the first regression formula is a regression formula showing the relationship between the actual age and the sound tooth number sought based on the statistical data regarding the age-specific average value of the sound tooth number, the second regression formula is a regression formula showing the relationship between the actual age and the sound sextant number sought based on the statistical data regarding the age-specific average value of the sound gingival sextant number, and the third regression formula is a regression formula showing the relationship between the two estimated ages and actual ages sought in the first and second regression formulae. Thereupon, in relation to the calculation of the oral cavity age, the conventional art inputs the sound tooth number of the consultee in relation to the first regression formula to seek the first estimated age and inputs the sound gingival sextant number of the consultee in relation to the second regression formula to seek the second estimated age, and seeks the estimated age (oral cavity age) of the consultee by inputting such first and second estimated ages in relation to the third regression formula.

The oral cavity age presented as an objective index in the conventional art is subject to a requirement of some type of statistical data as described above. Thus, if the sample matrix of the statistical data is varied, there is a possibility that the oral cavity age may change even if data of the same consultee during the same period is used. Moreover, if the statistical data as the basis for calculating the oral cavity age is fixed in order to avoid this kind of change in the oral cavity age, even if the statistical data is renewed in reality, such renewal will no longer be reflected in the oral cavity age. As a result, the object of the conventional art cannot be achieved since the significance of the calculated oral cavity age will be reduced.

To continue, for example, claim 3 of the conventional art employs a fifth degree polynomial expression as the first regression formula and a fourth degree polynomial expression as the second regression formula. Thus, if the statistical data is renewed, it can hardly be said that the degree of such polynomial expressions will be adequate, and there is no choice but to say that this lacks objectiveness.

To summarize, the oral cavity age in the conventional art is able to achieve its object only when such age is calculated based on specific statistical data. And it can also be said that such oral cavity age is only effective at the time of calculation. This type of characteristic arises because the oral cavity age in the conventional art is not a value intrinsic to the consultee, but is a comparative assessment value with the assessment data samples.

Contrarily, the index currently demanded in the dentistry field is an index effective in comprehending the secular changes of the intraoral condition of the consultee in order to devise an appropriate treatment program and to confirm the appropriateness of such treatment program. In other words, regarding the index demanded in the dentistry field, it will be insufficient if the index only has a characteristic as the comparative assessment in relation to the assessment data samples, and the index must also have an aspect of absolute assessment enabling the judgment of the intraoral condition intrinsic to the consultee even after the lapse of time.

Nevertheless, with respect to this point, there is a problem with the oral cavity age proposed in the conventional art in that it is not able to satisfy the demands in the foregoing field of dentistry.

Accordingly, an object of the present invention is to provide, upon proposing an index that is effective, easier and more suitable in judging the intraoral condition intrinsic to the consultee in comparison to the oral cavity age of the conventional art, a method (auxiliary method for intraoral condition judgment) for presenting information necessary in assisting the judgment employing such index.

### SUMMARY OF THE INVENTION

Under the premise to overcome the foregoing problems, the present invention calculates points from two assessments relating to the condition of the dental framework and periodontal framework for each tooth upon targeting a total of 28 teeth required to maintain a healthy mouth, and, by adding such points, represents the overall health condition of the mouth as an “age”, and proposes this tooth age as a new index. Moreover, the present invention provides the following auxiliary method for intraoral condition judgment for calculating and presenting such tooth age in order to assist in the judgment employing this index. “Teeth” as used in the present invention not only refers to permanent teeth, but also refers to baby teeth and artificial teeth. The assessment method of permanent teeth and baby teeth and artificial teeth may be the same or may be independently set in accordance with the type of teeth.

It is desirable that the number of teeth targeted for assessment be set to 28. Nevertheless, it is not always necessary to assess 28 teeth, and an embodiment where 14 to 28 teeth are assessed in consideration of the purpose of assessment and various circumstances may be employed. For instance, an embodiment of assessing the teeth of only the upper jaw or an embodiment of assessing only the anterior teeth may be employed.

[1] According to the present invention, the first auxiliary method for intraoral condition judgment is an auxiliary method for intraoral condition judgment executed with a processor on a computer system comprising storage means; the processor operating in accordance with the command from the software stored in the storage means; and display means for conducting display in accordance with the control of the processor;

the auxiliary method for intraoral condition judgment comprising:

a first step of presenting on the display means an input screen for inputting points, which are points relating to each of the 28 teeth in total, in accordance with the predetermined assessment criterion, and prompting the operator to input points;

a second step of retaining the points regarding each tooth input in the storage means;

a third step of reading the points regarding each tooth retained in the storage means; and

a fourth step of displaying the calculated tooth age on the display means and presenting the tooth age to the operator;

wherein the tooth age is provided to the operator as effective auxiliary information upon the operator judging the intraoral condition.

According to the foregoing auxiliary method for intraoral condition judgment, the consultee's tooth age that may be used as an auxiliary material upon judging the intraoral condition can be directly calculated from the tooth condition of such consultee, and this is beneficial in judging the intraoral condition intrinsic to the consultee.

[2] Moreover, according to the present invention, the second auxiliary method for intraoral condition judgment is an auxiliary method for intraoral condition judgment according to the first auxiliary method for intraoral condition judgment above;

wherein the assessment criterion prescribes an assessment such that the worst condition is set as 5 points for the dental framework and periodontal framework, respectively, in relation to the remaining teeth, and predetermined to provide 10.7 for lost teeth;

the input screen in the first step displays, for each tooth, a point-input column of the dental framework and periodontal framework, respectively, and a check column to be checked in cases when the tooth has been lost;

the second step judges whether the checking column has been checked in the input screen for each tooth, and, when checked, retains 10.7 as the point of the tooth in the storage means on the one hand, and, when not checked, retains the total number of points input in the point-input column of the dental framework and periodontal framework, respectively, as the point of the tooth in the storage means; and

the third step seeks the tooth age with the value obtained by dividing the total number of points of the each tooth by three.

According to the foregoing auxiliary method for intraoral condition judgment, the calculated tooth age will take the value between ages 0 and 100, and each consultee will be able to viscerally recognize the consultee's personal intraoral condition.

In the foregoing judgment auxiliary method, the point is set to 0 if the tooth condition is intact (best condition), set to 5 if in the worst condition, and set to 10.7 if the tooth has been lost. The tooth condition is assessed with the total number of points of the dental framework and periodontal framework. If both the dental framework and periodontal framework are of the worst condition, the calculation will be dental framework (5 points)+periodontal framework (5 points)=10 points in total.

Points showing that the dental framework and periodontal frame are of the worst condition may be set to be the same point, or may be suitably changed. For example, an embodiment where the worst condition of the dental framework is set to 6 points and the worst condition of the periodontal frame is set to 4 points may be adopted.

It is optimum that the points given to lost teeth is 1.07 times the points given to the teeth of the worst condition. Nevertheless, the foregoing is not limited to such value, and the points that may be given to lost teeth may be set to a value that is 1.03 to 1.10 times the points given to the worst condition.

[3] Further, according to the present invention, the third auxiliary method for intraoral condition judgment is an auxiliary method for intraoral condition judgment according to the second auxiliary method for intraoral condition judgment above;

wherein the third step seeks the tooth age by reading the points of each tooth from the storage means and seeking the total number of points, and thereafter dividing the total number of points by three.

It is not necessary to limit the value for dividing the foregoing total number of points to three, and it will be sufficient to make a suitable setting capable of displaying the condition of having lost all teeth as 100 and the best condition as 0. For instance, in an embodiment where the total number of points of the worst condition is 250 points, the total number of points is divided by 2.5.

[4] Moreover, according to the present invention, the fourth auxiliary method for intraoral condition judgment is an auxiliary method for intraoral condition judgment according to the second auxiliary method for intraoral condition judgment above;

wherein the third step seeks the tooth age by repeating, for all teeth, the processing of sequentially adding the value obtained by reading the points of each tooth from the storage means and dividing it by three.

[5] Further, according to the present invention, the fifth auxiliary method for intraoral condition judgment is an auxiliary method for intraoral condition judgment according to the second auxiliary method for intraoral condition judgment above, further comprising:

a step of previously retaining in the storage means sequential line graph data which is used for employing the auxiliary method for intraoral condition judgment in a prescribed number of samples and seeking the tooth age of the individual samples, and displaying on the display means the statistical data, as the sequential line graph, created by taking statistics upon associating the tooth age with the actual age of the individual samples; and

a step of controlling the display means for displaying the sequential line graph on the display means based on the sequential line graph data and plotting the tooth age sought in the third step on the sequential line graph.

Thereby, since the relationship between the sequential line graph and the plotted data is displayed in a visually recognizable state, it is possible to know to resistance of the consultee's mouth against illnesses, and the treatment program can be devised easily as a result thereof.

[6] Moreover, the calculation and display function of the tooth age based on the foregoing auxiliary method for intraoral condition judgment is may be realized with a CPU or through the association of a processor and software as described above, or as hardware.

Further, in order to realize such auxiliary method for intraoral condition judgment described above, this may be materialized in the form of a program containing commands and the like to be executed with a CPU or processor.

### BRIEF DESCRIPTION OF THE DRAWINGS

FIG. 1 is a system structure diagram of the auxiliary device for intraoral condition judgment according to an embodiment of the present invention;

FIG. 2 is a flowchart showing the auxiliary method for intraoral condition judgment according to an embodiment of the present invention;

FIG. 3 is a diagram showing the assessment criterion according to an embodiment of the present invention;

FIG. 4 is a diagram showing the input screen for inputting points regarding each tooth;

FIG. 5 is a diagram showing the screen displaying the tooth age calculated with the auxiliary method for intraoral condition judgment according to an embodiment of the present invention; and

FIG. 6 is a diagram showing the format data of comparative assessment.

### DESCRIPTION OF THE PREFERRED EMBODIMENTS

The auxiliary method for intraoral condition judgment according to the embodiments of the present invention is now explained in detail with reference to the drawings.

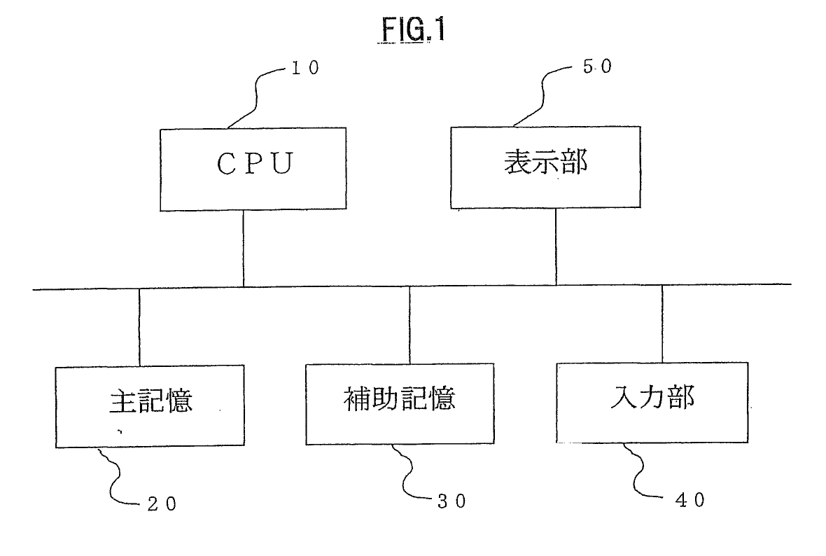

The auxiliary device for intraoral condition judgment according to the embodiments of the present invention comprises, as shown in FIG. 1, a CPU (or processor) 10, a main memory 20, an auxiliary memory 30, an input unit 40 and a display unit 50.

The main memory 20, for instance, is structured of a DRAM, and the auxiliary memory 30, for example, is structured with the likes of an HDD or CD-ROM. Further, the input unit 30, for instance, is structured with likes of a keyboard or mouse, and the display unit 40, for example, is structured with the likes of a CRT or liquid crystal display.

In detail, the auxiliary memory 30 stores software commands for making the CPU 10 execute the auxiliary method for intraoral condition judgment according to the present embodiment. These software commands are deployed on the main memory 20, and the CPU 10 operates in accordance with the software commands deployed on this main memory 20. Moreover, the main memory 20 temporarily stores the data generated while the CPU 10 is operating in accordance with such software commands and the data utilized by the CPU 10. Further, according to the present day computer technology, when realizing the present invention on a computer system, a structure of separating the main memory 20 and auxiliary memory 30 is mainly adopted as described above, but the two memories may be conceptually considered to be a single storage means.

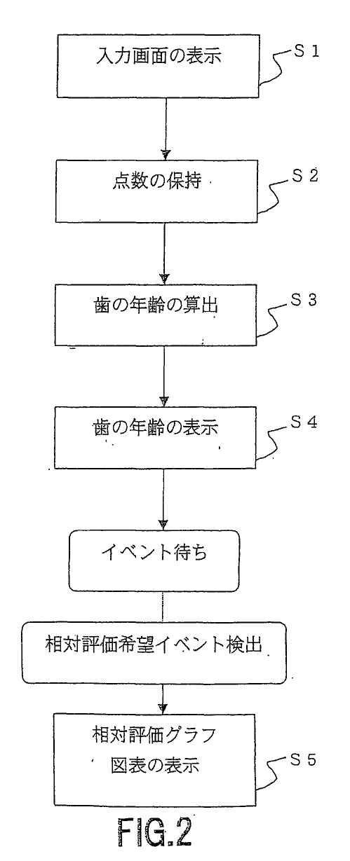

In the auxiliary device for intraoral condition judgment comprising this type of structure, the calculation and display of the tooth age are generally conducted as illustrated in FIG. 2 by the CPU 10 executing the software commands deployed (stored) in the main memory 20 as described above.

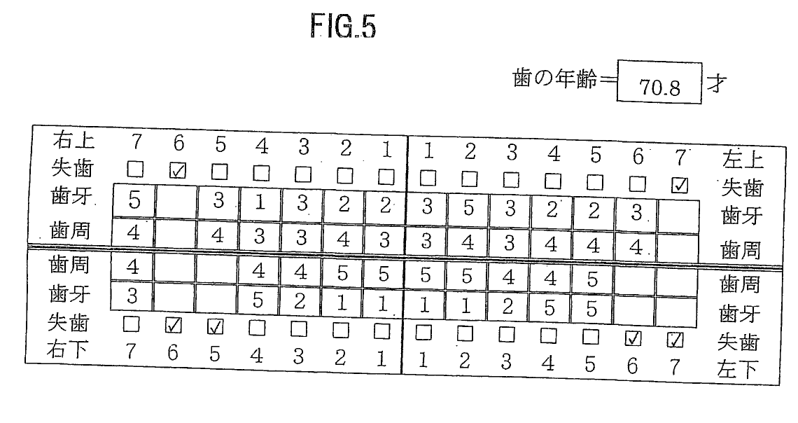

Foremost, upon performing the auxiliary method for intraoral condition judgment according to the embodiment of the present invention described below, the comparative assessment format data of intrinsic resistance (c.f. FIG. 5 (sic.), described later) is previously stored in the auxiliary memory 30. This comparative assessment format data is data of the sequential line graph prepared based on the statistics obtained upon executing the auxiliary method for intraoral condition judgment described below in relation to a prescribed number of samples (consultees).

Moreover, the operator to implement the auxiliary method for intraoral condition judgment according to the present invention is previously notified of the assessment criterion employed for giving points to each tooth. This assessment criterion prescribes the assessment such that 5 points are given to the dental framework and periodontal framework, respectively, in relation to the remaining teeth, and, if both the dental framework and periodontal framework are of the worst condition, a total of 10 points will be given. Further, the foregoing assessment criterion is prescribed to give 10.7 points for each lost tooth.

Under these conditions, foremost, an input screen for inputting points relating to each of the 28 teeth in total is displayed on the display unit 50 (step S1). This input screen displays, for each tooth, the respective point-input columns of the dental framework and periodontal framework, and the check column to be checked when such tooth has been lost. When this input screen is displayed on the display unit 50, the operator inputs points relating to each tooth of the consultee in accordance with the foregoing assessment criterion.

When the operator inputs points or indicates a check for each tooth, the points input for each tooth are retained in the main memory 20 (step S2). In detail, it is judged whether the check column has been checked in the input screen for each tooth, and, 10.7 points are retained in the main memory 20 as the points of such tooth when a check as been indicated. Meanwhile, if a check has not been indicated, the total number of points input in the respective point-input columns of the dental framework and periodontal framework is retained in the main memory 20 as the points of such tooth.

Next, the tooth age is calculated based on the points regarding each tooth (step S3). In the present embodiment, after the points are input and checks are indicated for all teeth, the points regarding each tooth retained in the main memory 20 are read, the total number of points in relation to each tooth is sought, and the value obtained by dividing such total number of points by three is calculated as the tooth age. Each time points are input regarding each tooth, such points may be divided by three as needed, the values obtained by such division of three may be added sequentially, and, in each case, such value may be calculated as the tooth age. Even in such a case, the initially intended tooth age will be displayed after the points for all teeth have been input. Incidentally, in the present embodiment, the division is made by “2.996” and not “3” in consideration of the calculation with a computer system.

The tooth age calculated as above will be between the age of 0 and 100, and displayed on the display unit 50 (step S4). The tooth age may thereby be known. Further, since the health condition of the mouth is represented in ages where the age will be 0 if the teeth do not have any disease and are of a sound state and 100 if all of the teeth have been lost, the displayed tooth age will be notified to the consultee, and there is a benefit in that the consultee, who does not have any professional knowledge, can easily image his/her intraoral condition.

Moreover, after displaying the calculated tooth age on the display unit 50 at step S4, the routine temporarily enters an event standby state. Thereafter, when an event representing the wish to perform comparative assessment arises, the foregoing comparative assessment format data is read from the auxiliary memory 30, the tooth age calculated on such data is combined therewith, and the graph chart in which the tooth age is plotted on the sequential line graph is displayed on the display unit 50 (step S5).

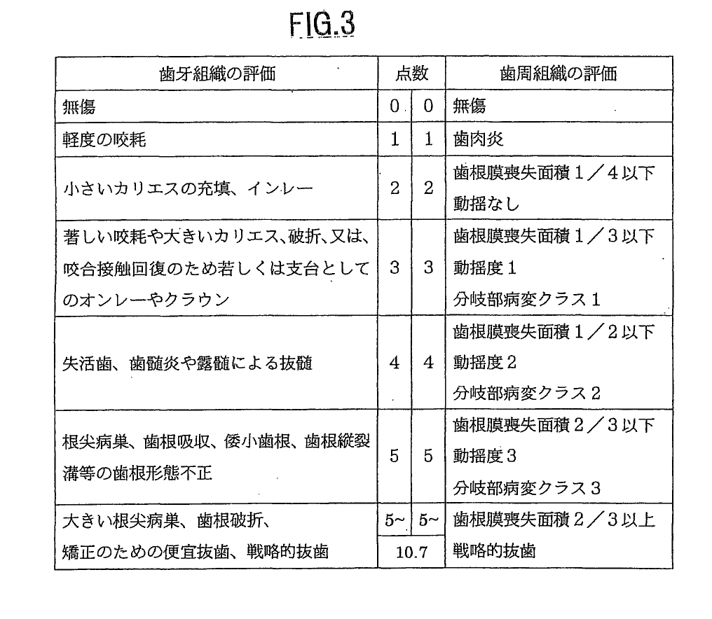

Next, an example of the auxiliary method for intraoral condition judgment is described in more detail with reference to FIG. 3 to FIG. 5.

FIG. 3 is a chart illustrating the assessment criterion according to the present embodiment, and this chart is distributed in advance to the operator implementing the auxiliary method for intraoral condition judgment. As can be understood by referring to FIG. 3, in the assessment criterion, a 5-level assessment criterion from 1 point to 5 points is set for the dental framework and periodontal framework, respectively. Moreover, 10.7 points are set for extracted teeth. When the dental framework is intact, 0 points are given. Similarly, 0 points are also given when the periodontal framework is intact. According to this assessment, for instance, 4+4=8 points are given to a tooth from which nerves have been removed and wherein the loss area of the periodontal membrane is ⅔ or less.

By giving points to each tooth in accordance with this assessment criterion, not only will the symptoms described by the consultee be reflected, the judgment based on the physician's profession knowledge will also be reflected. Moreover, as a result of having prescribe the assessment criterion as described above, when a dentist having a certain degree of diagnostic ability and understanding the calculation criterion gives the points, the tooth age calculated thereby will become an approximately fixed numerical value, and a highly reliable index can thereby be obtained.

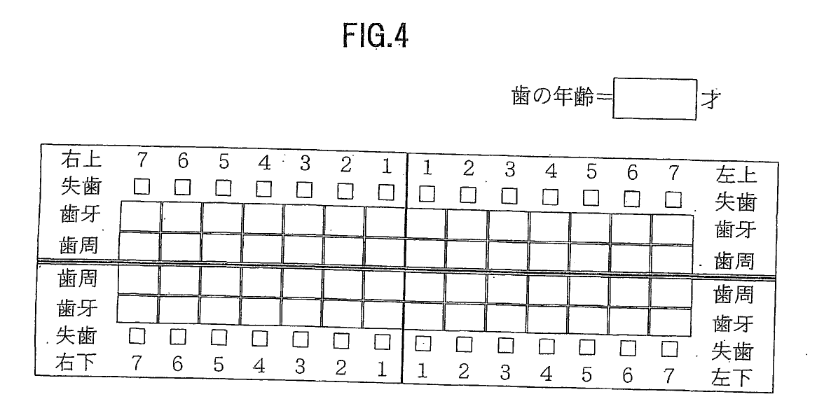

The input screen illustrated in FIG. 4 is displayed to the operator having this assessment criterion. In FIG. 4, with the up/down/left/right boundary positions as the starting point, seven point-input columns are drawn in the upper left, upper right, lower right and lower left positions in the first to fourth phenomena. Regarding the upper left first to seventh teeth (first phenomenon) and the upper right first to seventh teeth (second phenomenon), a checkbox for checking tooth loss, a point-input column for inputting the assessment points for the dental framework, and a point-input column for inputting assessment points for the periodontal framework are provided. Meanwhile, regarding the lower right first to seventh teeth (third phenomenon) and the lower left first to seventh teeth (fourth phenomenon), a checkbox for checking tooth loss, a point-input column for inputting the assessment points for the dental framework, and a point-input column for inputting assessment points for the periodontal framework are provided.

As a result of inputting point of each tooth or checking the checkboxes in the input screen depicted in FIG. 4, the tooth age is calculated as described above, and, as shown in FIG. 5, the calculated tooth age is displayed in the blank space shown in the upper right corner of the diagram.

When the comparative assessment selection button (not shown) is pressed after the tooth age has been calculated as described above, a comparative assessment selection event occurs. When the occurrence of this comparative assessment selection event is detected, processing for combining the tooth age calculated on the comparative assessment format data is performed.

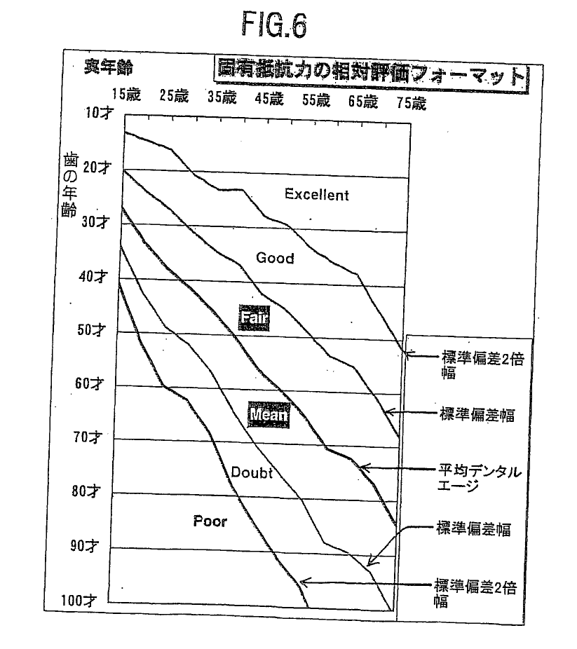

Here, the comparative assessment format data in the present embodiment can be obtained as follows. Foremost, the distribution of the tooth age obtained from a prescribed number of samples having a similar actual age is deemed to be the normal distribution, and the average value and standard deviation of such tooth age are calculated. A line passing through the average value of the tooth age in each actual age is set to be the reference line (this corresponds to the sequential line graph in the present embodiment), and the two lines (sequential line graph) passing through the value separated from the reference line to the standard deviation in each actual age and the two lines (sequential line graph) passing through the value separated twice the distance from the reference line to the standard deviation in each actual age are used, and a total of six areas divided with the foregoing 5 lines. The respective areas in the comparative assessment format data created as described above are named in the present embodiment, in order from the smaller tooth age, as Excellent, Good, Fair, Mean, Doubt, and Poor. FIG. 6 illustrates the comparative assessment format data obtained as described above.

In the present embodiment, the combination of the tooth age on the comparative assessment format data is performed upon

plotting such tooth age on a plurality of sequential line graphs. In other words, the plotted tooth age will belong to one of the areas among the 6 areas divided with a plurality of sequential line graphs.

As a result of visually recognizing the relationship between the comparative assessment format and the plotted tooth age, the operator will be able to obtain materials for judging whether or not the biological resistance intrinsic to the consultee is strong, and an effective treatment program may be devised thereby.

Although specific examples have been exemplified in the foregoing embodiments to assist in the understanding of the present invention, the concept of this invention is in no way limited thereto.

For example, in the embodiment described above, although an explanation was given where any age between 0 and 100 is adopted with teeth in the healthiest condition being set to age 0 and cases where all teeth have been lost being set to 100, the tooth age calculated above may be subtracted from 100 to display the remaining duration of life. Moreover, instead of using age, a % mark may be displayed.

Needless to say, the present invention is not in any way limited by the foregoing embodiments, may be modified variously within the scope of the invention claimed in the claims, and such modifications are also included herein.

Further, the term “means” as used in the specification does not necessarily means a physical means, but also includes cases where the functions of the respective means are realized with software. Moreover, the function of a single means may be realized with two or more physical means, and the functions of two or more means may be realized with a single physical means.

### INDUSTRIAL APPLICABILITY

As described above, the present invention calculates points from two assessments relating to the condition of the dental framework and periodontal framework for each tooth upon targeting a total of 28 teeth required to maintain a healthy mouth, and, by adding such points, represents the overall health condition of the mouth as a tooth age, and further proposes the use of hardware resources for realizing the calculating such tooth age. Auxiliary information effective upon judging the intraoral condition is thereby obtained.

FIG. 1

20 Main Memory

30 Auxiliary Memory

40 Input Unit

50 Display Unit

FIG. 2

S1 Display of Input Screen

S2 Maintenance of Mark

S3 Calculation of Teeth Age

S4 Display of Teeth Age

Waiting for Event

Detection of Desired Event for Comparative Assessment

S5 Display of Comparative Assessment Graph Chart

FIG. 3

Assessment of Dental Framework

Mark

0 Intact

1 Slight Tooth Attrition

2 Filling and Inlay of Small Caries

3 Significant Tooth Attrition or Large Caries, Tooth Fracture, or Onlays or Crowns for Recovery of Occlusal Contact or as an Abutment

4 Dental Pulp Extraction due to Devitalized Tooth, Pulpitis or Exposure

5 Irregular Root Form due to Apical Lesion, Root Resorption, Small Roots, Root Scissure, etc.

5+ Large Apical Lesion, Root Breakage

10.7 Expedient Tooth Extraction, Strategic Tooth Extraction for Correction

Assessment of Periodontal Framework

Mark

0 Intact

1 Gingivitis

2 Loss Area of Periodontal Membrane is ¼ or Less

No Agitation

3 Loss Area of Periodontal Membrane is ⅓ or Less

Degree of Agitation 1

Bifurcation Lesion Class 1

4 Loss Area of Periodontal Membrane is ½ or Less

Degree of Agitation 2

Bifurcation Lesion Class 2

5 Loss Area of Periodontal Membrane is ⅔ or Less

Degree of Agitation 3

Bifurcation Lesion Class 3

5+ Loss Area of Periodontal Membrane is ⅔ or Less

10.7 Strategic Tooth Extraction

FIG. 4

Tooth Age=______ Year(s) of Age

Upper Right Upper Left

Tooth Loss Tooth Loss

Teeth Teeth

Gums Gums

Gums Gums

Teeth Teeth

ooth Loss Tooth Loss

Lower Right Lower Left

FIG. 5

Tooth Age=70.8 Years of Age

Upper Right Upper Left

Tooth Loss Tooth Loss

Teeth Teeth

Gums Gums

Gums Gums

Teeth Teeth

Tooth Loss Tooth Loss

Lower Right Lower Left

FIG. 6

Comparative Assessment Format of Intrinsic Resistance

Actual Age: 15, 25, 35, 45, 55, 65, 75

Tooth Age: 10, 20, 30, 40, 50, 60, 70, 80, 90, 100

Double the Standard Deviation Width

Standard Deviation Width

Average Dental Age

Standard Deviation Width

Double the Standard Deviation Width

What is claimed is:

1. An auxiliary method for intraoral condition judgment executed with a processor on a computer system comprising storage means; said processor operating in accordance with the command from the software stored in said storage means; and display means for conducting display in accordance with the control of said processor;
said auxiliary method for intraoral condition judgment comprising:
a first step of presenting on said display means an input screen for inputting points, which are points relating to each of the 28 teeth in total, in accordance with the predetermined assessment criterion, and prompting the operator to input points;
a second step of retaining the points regarding each tooth input in said storage means;
a third step of reading the points regarding each tooth retained in said storage means and calculating the tooth age in accordance with the total number of points of every tooth; and
a fourth step of displaying the calculated tooth age on said display means and presenting said tooth age to said operator;
wherein said tooth age is provided to said operator as effective auxiliary information upon said operator judging the intraoral condition.

2. An auxiliary method for intraoral condition judgment according to claim 1;
wherein said assessment criterion prescribes an assessment such that the worst condition is set as 5 points for the dental framework and periodontal framework, respectively, in relation to the remaining teeth, and predetermined to provide 10.7 for lost teeth;
said input screen in said first step displays, for each tooth, a point-input column of the dental framework and periodontal framework, respectively, and a check column to be checked in cases when said tooth has been lost;
said second step judges whether said checking column has been checked in said input screen for each tooth, and, when checked, retains 10.7 as the point of said tooth in said storage means on the one hand, and, when not checked, retains the total number of points input in the point-input column of said dental framework and periodontal framework, respectively, as the point of said tooth in said storage means; and
said third step seeks said tooth age with the value obtained by dividing the total number of points of said each tooth by three.

3. An auxiliary method for intraoral condition judgment according to claim 2;
wherein said third step seeks said tooth age by reading the points of each tooth from said storage means and seeking said total number of points, and thereafter dividing said total number of points by three.

4. An auxiliary method for intraoral condition judgment according to claim 2;
wherein said third step seeks said tooth age by repeating, for all teeth, the processing of sequentially adding the value obtained by reading the points of each tooth from said storage means and dividing it by three.

5. An auxiliary method for intraoral condition judgment according to claim 2, further comprising:
a step of previously retaining in said storage means sequential line graph data which is used for employing said auxiliary method for intraoral condition judgment in a prescribed number of samples and seeking the tooth age of the individual samples, and displaying on said display means the statistical data, as the sequential line graph, created by taking statistics upon associating said tooth age with the actual age of the individual samples; and
a step of controlling said display means for displaying said sequential line graph on said display means based on said sequential line graph data and plotting the tooth age sought in said third step on said sequential line graph.

6. An auxiliary device for intraoral condition judgment comprising a processor; display means controlled by said processor; and storage means for storing software commands for making said processor execute prescribed processing;
wherein said prescribed processing includes:
a first step of displaying on said display means an input screen for inputting points, which are points relating to each of the 28 teeth in total, in accordance with the predetermined assessment criterion;
a second step of retaining the points regarding each tooth input in said storage means;
a third step of reading the points regarding each tooth retained in said storage means; and
a fourth step of displaying the calculated tooth age on said display means;
wherein said tooth age is provided to said operator of said auxiliary device for intraoral condition judgment as effective auxiliary information upon said operator judging the intraoral condition.

7. An auxiliary device for intraoral condition judgment according to claim 6;
wherein said assessment criterion prescribes an assessment such that the worst condition is set as 5 points for the dental framework and periodontal framework, respectively, in relation to the remaining teeth, and predetermined to provide 10.7 for lost teeth;
said input screen in said first step displays, for each tooth, a point-input column of the dental framework and periodontal framework, respectively, and a check column to be checked in cases when said tooth has been lost;
said second step judges whether said checking column has been checked in said input screen for each tooth, and, when checked, retains 10.7 as the point of said tooth in said storage means on the one hand, and, when not checked, retains the total number of points input in the point-input column of said dental framework and periodontal framework, respectively, as the point of said tooth in said storage means; and
said third step seeks said tooth age with the value obtained by dividing the total number of points of said each tooth by three.

8. An auxiliary device for intraoral condition judgment according to claim 7;
wherein said third step seeks said tooth age by reading the points of each tooth from said storage means and seeking said total number of points, and thereafter dividing said total number of points by three.

9. An auxiliary device for intraoral condition judgment according to claim 7;
wherein said third step seeks said tooth age by repeating, for all teeth, the processing of sequentially adding the value obtained by reading the points of each tooth from said storage means and dividing it by three.

10. An auxiliary device for intraoral condition judgment according to claim 7;
said prescribed processing further comprising:
a step of previously retaining in said storage means sequential line graph data which is used for seeking the tooth age of each of the prescribed number of samples, and displaying on said display means the statistical data, as the sequential line graph, created by taking statistics upon associating said tooth age with the actual age of the individual samples; and
a step of controlling said display means for displaying said sequential line graph on said display means based on said sequential line graph data and plotting the tooth age sought in said third step on said sequential line graph.

11. An auxiliary program for intraoral condition judgment for making a processor execute prescribed processing in a computer system comprising said processor, storage means and display means and making said computer system function as an auxiliary device for intraoral condition judgment;
wherein said prescribed processing includes:
a first step of presenting on said display means an input screen for inputting points, which are points relating to each of the 28 teeth in total, in accordance with the predetermined assessment criterion, and prompting the operator to input points;
a second step of retaining the points regarding each tooth input in said storage means;
a third step of reading the points regarding each tooth retained in said storage means and calculating the tooth age in accordance with the total number of points of every tooth; and
a fourth step of displaying the calculated tooth age on said display means and presenting said tooth age to said operator;
wherein said tooth age is provided to said operator as effective auxiliary information upon said operator judging the intraoral condition.

12. An auxiliary program for intraoral condition judgment according to claim 11;
wherein said assessment criterion prescribes an assessment such that the worst condition is set as 5 points for the dental framework and periodontal framework, respectively, in relation to the remaining teeth, and predetermined to provide 10.7 for lost teeth;
said input screen in said first step displays, for each tooth, a point-input column of the dental framework and periodontal framework, respectively, and a check column to be checked in cases when said tooth has been lost;
said second step judges whether said checking column has been checked in said input screen for each tooth, and, when checked, retains 10.7 as the point of said tooth in said storage means on the one hand, and, when not checked, retains the total number of points input in the point-input column of said dental framework and periodontal framework, respectively, as the point of said tooth in said storage means; and
said third step seeks said tooth age with the value obtained by dividing the total number of points of said each tooth by three.

13. An auxiliary program for intraoral condition judgment according to claim 12;
wherein said third step seeks said tooth age by reading the points of each tooth from said storage means and seeking said total number of points, and thereafter dividing said total number of points by three.

14. An auxiliary method for intraoral condition judgment according to claim 12;
wherein said third step seeks said tooth age by repeating, for all teeth, the processing of sequentially adding the value obtained by reading the points of each tooth from said storage means and dividing it by three.

15. An auxiliary program for intraoral condition judgment according to claim 12;
said prescribed processing further comprising:
a step of previously retaining in said storage means sequential line graph data which is used for employing said auxiliary method for intraoral condition judgment in a prescribed number of samples and seeking the tooth age of the individual samples, and displaying on said display means the statistical data, as the sequential line graph, created by taking statistics upon associating said tooth age with the actual age of the individual samples; and
a step of controlling said display means for displaying said sequential line graph on said display means based on said sequential line graph data and plotting the tooth age sought in said third step on said sequential line graph.
